(19) United States
(12) Patent Application Publication
(10) Pub. No.: US 2002/0046441 A1
(43) Pub. Date: Apr. 25, 2002

(54) Hinge

(76) Inventor: Klaus Brustle, Hochst (AT)

Correspondence Address: WENDEROTH, LIND & PONACK, L.L.P., 2033 K STREET N. W., SUITE 800, WASHINGTON, DC, 20006-1021, US

(21) Appl. No.: 09/964,689

(22) Filed: Sep. 28, 2001

(30) Foreign Application Priority Data
Oct. 19, 2000 (AT) A 1792/2000

(51) Int. Cl. E05D 7/10

(52) U.S. Cl. 16/254

(57) ABSTRACT

A hinge for pieces of furniture comprising a hinge arm (2) and a hinge casing (1) which are connected to each other by means of at least one hinge axle. The hinge arm (2) is provided with a fluid damper (20). The fluid damper is mounted on the side of the hinge arm without the use of a tool.

### BACKGROUND OF THE INVENTION

The invention relates to a hinge comprising a hinge arm hingeably connected to a hinge casing, said hinge casing being tiltable with respect to said hinge arm between and open and a closed position.

It is known to provide pieces of furniture with damping devices to prevent banging of the doors or drawers when they are closed.

The DE 2539954 shows a hinge having an elastically deformable damping element. The damping action of such a damping element is not very significant.

Lately pieces of furniture are provided with fluid dampers. Beside linear dampers in the form of pneumatic or hydraulic dampers, rotary dampers are also in use.

These rotary dampers generally are provided with a housing in which a rotor is mounted. A damping fluid for example silicon oil is provided within the housing. By means of the damping fluid a very good damping effect is achieved when a door or a drawer are moved with too much force.

According to the prior art these damping devices are provided either in the form of a separate damper, on a piece of furniture or they are integral with a hinge.

### SUMMARY OF THE INVENTION

It is the object of the invention to provide an improved hinge which can be selectively provided with a fluid damping device. It is a further object of the invention that the damping device can be easily mounted on a hinge ready for use.

According to the invention this object is achieved by providing a fluid damper having a housing and an actuating member moveably mounted in that housing said housing being mounted on a side of said hinge arm said actuating member abutting said hinge casing when the latter is in its closed position.

An embodiment of the invention provides that the hinge arm has U-shaped configuration with a middle web and two side webs said housing being mounted on the middle web.

The housing is preferably held on the hinge arm by means of a protrusion protruding into a hole in the middle web of said hinge arm. The protrusion can be either in the form of a hook or in the form of an elastically deformable peg which is squeezed into the hole in the middle web of the hinge arm.

The actuating member is in the form of a slide linearly moveable within said housing. A piece of furniture according to the invention is provided with a fluid damper having a housing and an actuating member moveably mounted in said housing, said housing being mounted on a side of said hinge arm; said actuating member abutting the door when the door is in its closed position.

### BRIEF DESCRIPTION OF THE DRAWINGS

In the following embodiments of the invention will be described in more detail with reference to the companing drawings wherein:

FIG. 1 is a diagrammatically view of a hinge according to the invention,

FIG. 2 is a diagrammatically view of a hinge according to the invention and a damper, the two parts being shown apart,

FIG. 3a and b are side views of a damper,

FIG. 4 is a sectional view along line I-I of FIG. 3a

FIG. 5 is a sectional view along line II-II of FIG. 3a

FIG. 6 is a side view of a hinge according to the invention in the closed position and

FIG. 7 is a side view of a hinge according to the invention in the opened position.

### DETAILED DESCRIPTION OF THE INVENTION

A hinge according to the invention is provided with a hinge casing 1 and a hinge arm 2. The hinge casing 1 and the hinge arm 2 are connected by means of an outer hinge link 3 and an inner hinge link 4. The hinge links 3 and 4 are mounted on axles 5, 6 of the hinge arm 2 and the hinge casing 1.

The hinge arm 2 has a U-shaped configuration with a middle web 2′ and two side webs 2″.

The hinge arm 2 is mounted on an intermediate piece by means of at least one adjustment screw for adjusting the position of the hinge arm in a direction perpendicular to the side wall 11 of the piece of furniture. Advantageously a second adjustment screw or an adjustment disk for adjusting the position of the hinge arm 2 in the direction of the depth of the piece of furniture is provided.

The hinge casing 1 is mounted in a bore in the door 12 of the piece of furniture. The hinge arm 2 together with the intermediate piece is mounted on the base plate 10 which is fastened to a side wall 11 of the piece of furniture.

The middle web 2′ of the hinge arm 2 is provided with a hole 7. Because of the hole 7 it is possible to turn the adjustment screw in the intermediate piece or in the mounting plate 10 by means of screw driver.

A hinge of this kind is described in more detail in the U.S. patent specification 60/32,333 of the applicant.

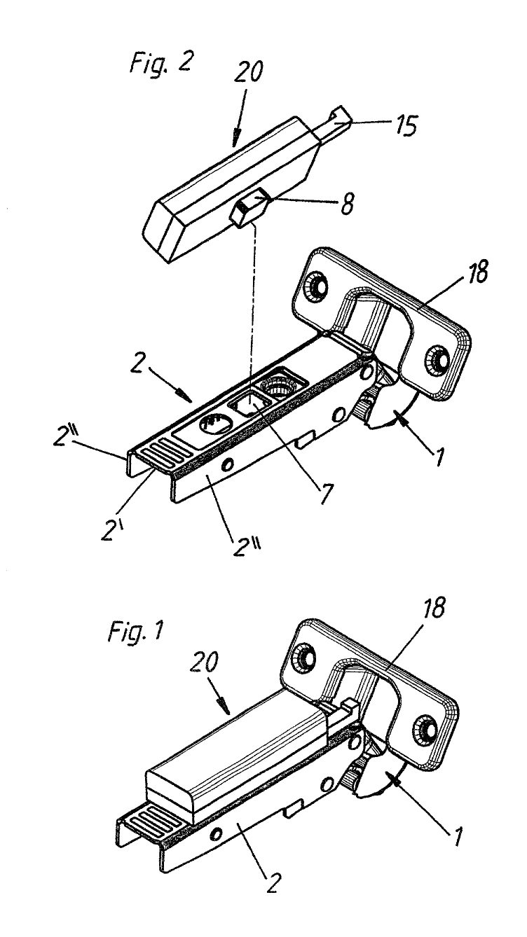

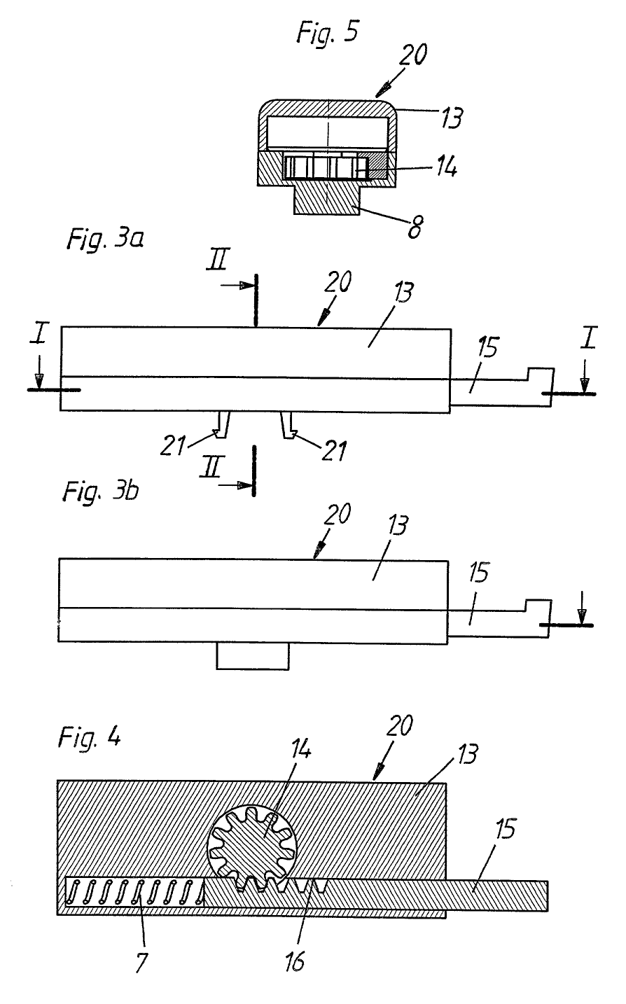

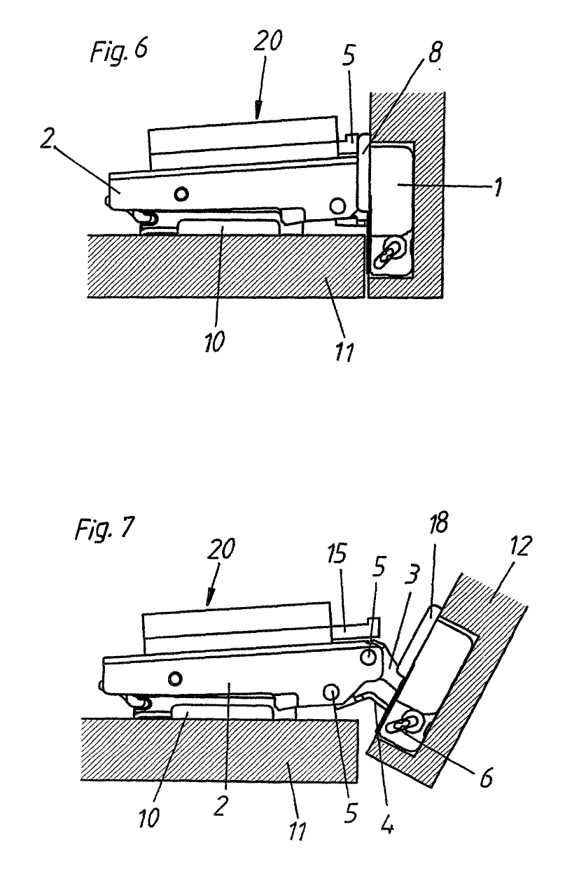

A hinge of this kind can now be provided with a damper 20 according to the invention. The damper 20 has a housing 13 with a mounting projection 8. The damper 20 is mounted on the middle web 2′ of the hinge arm 2 whereby the peg like mounting projection 8 is squeezed into the opening 7 of the hinge arm 2. The mounting projection 8 is advantageously elastically deformable so that the mounting projection 8 is clamped in the hole 7 (FIGS. 2, 3a).

In the embodiment of FIG. 3b the housing 13 is provided with two hooks 21 which protrude into the hole 7 of the hinge arm 2 thereby clamping the housing 13 to the hinge arm 2. In both cases the damper 20 can be mounted on the hinge arm 2 without the use of a tool.

In the embodiment shown the damper 20 in use is a rotary damper with a pinion 14 which is situated within the housing 13. The pinion 14 meshes with a rack 16 on a slide 15. The slide 15 is the actuating member of the damper 20. The slide 15 is linearly moveable within the housing 13 whereby a spring 17 acts on the slide 15 pushing the slide 15 into its stand-by position. When the door 12 is closed the flange 18 of the hinge casing 1 presses on to the slide 15 whereby the slide 15 is pushed into the housing 13. Thereby the pinion 14 is rotated and the closing movement of the door 12 is dampened.

After opening the door 12 the spring 17 again pushes the slide 15 into the stand-by position shown in FIG. 7.

In the embodiment shown the rotary damper is a fluid damper. Instead of a rotary damper other fluid dampers with linearly moveable pistons could be employed. These dampers could be pneumatic dampers as well as hydraulic dampers.

1. A hinge comprising a hinge arm hingeably connected to a hinge casing; said hinge casing being tiltable with respect to said hinge arm between an open and a closed position and further comprising, a fluid damper having a housing and an actuating member moveably mounted in said housing, said housing being mounted on a side of said hinge arm; said actuating member abutting said hinge casing when the latter is in its closed position.

2. A hinge as claimed in claim 1, wherein the hinge arm has U-shaped configuration with a middle web and two side webs said housing being mounted on the middle web.

3. A hinge as claimed in claim 2, wherein said housing is provided with a protrusion protruding into a hole in the middle web of said hinge arm.

4. A hinge as claimed in claim 3, wherein said protrusion is in the form of a hook.

5. A hinge as claimed in claim 3, wherein said protrusion is in the form of an elastically deformable peg which is squeezed into the hole in the middle web of said hinge arm.

6. A hinge as claimed in claim 1, wherein said actuating member is in the form of a slide linearly moveable within said housing.

7. A hinge as claimed in claim 6 wherein said hinge casing 5 is provided with a flange said slide abutting said flange when the hinge is in the closed position.

8. A hinge as claimed in claim 1, wherein the housing of said fluid damper is fastened to the hinge arm without a tool.

9. A hinge as claimed in claim 1, wherein said fluid damper is a linear damper.

10. A hinge as claimed in claim 9, wherein said linear damper is a pneumatic damper.

11. A hinge as claimed in claim 9, wherein said linear damper is a hydraulic damper.

12. A hinge as claimed in claim 1 wherein said damper is a rotary damper.

13. A piece of furniture with at least one hinge comprising a hinge arm fastened to a side wall of the piece of furniture and being hingeably connected to a hinge casing which is mounted in a door of the piece of furniture and further comprising, a fluid damper having a housing and an actuating member moveably mounted in said housing, said housing being mounted on a side of said hinge arm; said actuating member abutting the door of said piece of furniture when the door is in its closed position.
